(19) United States
(12) Patent Application Publication
(10) Pub. No.: US 2011/0131253 A1
(43) Pub. Date: Jun. 2, 2011

(54) System and Method of Schema Matching

(75) Inventors: Eric Peukert, Dresden (DE); Henrike Berthold, Dresden (DE); Julian Eberius, Dresden (DE)

(73) Assignee: SAP AG, Walldorf (DE)

(21) Appl. No.: 12/627,382

(22) Filed: Nov. 30, 2009

(51) Int. Cl. G06F 17/30

(52) U.S. Cl. 707/805; 707/E17.044

(57) ABSTRACT

In one embodiment the present invention includes computer-implemented method of performing schema matching. The method includes storing, by a computer system, a schema mapping that includes nodes. The schema mapping indicates a relationship between a first schema and a second schema. The method includes displaying, at a first node of the plurality of nodes, a graphical indication of the schema mapping at the first node. The method includes receiving, by the computer system, an evaluation of the schema mapping at the first node according to a user evaluating the graphical indication. The method includes adjusting the schema mapping as a result of the user evaluating the graphical indication. The method includes stepping, by the computer system, to a second node of the plurality of nodes. The method includes further displaying, receiving and adjusting the schema mapping as related to the second node.

### CROSS REFERENCE TO RELATED APPLICATIONS

Not applicable.

### BACKGROUND

The present invention relates to schema matching, and in particular, to graphical tools for evaluating a schema mapping.

Unless otherwise indicated herein, the approaches described in this section are not prior art to the claims in this application and are not admitted to be prior art by inclusion in this section.

A recurring task in data integration, ontology alignment or model matching is finding mappings between complex structures. Today, this time-consuming task is mainly tackled manually, often supported by point and click interfaces. In order to reduce the manual effort, a number of matching algorithms and high-level mapping operators for semi-automatically computing mappings were introduced. These algorithms and operators can be combined and configured within matching frameworks like COMA++. See S. Melnik, H. Garcia-Molina and E. Rahm, Similarity Flooding: A Versatile Graph Matching Algorithm and its Application to Schema Matching, Proceedings, 18th ICDE, pages 117-128 (2002). Unfortunately, the selection, combination and configuration of match algorithms as well as the use of mapping operators is complex and time-consuming so that only matching algorithm experts can exploit the full potential of auto matching. This is one of the reasons why semi-automatic matching techniques from research are only rarely applied within industrial products.

One enhancement is the development of a library for semi-automatic matching. Unfortunately, the requirements of the different matching use cases are very different, so that a huge manual effort is needed to configure and adjust the matching algorithms to a given use case. Changing the configuration after a product has been shipped is impossible or cumbersome.

### SUMMARY

Embodiments of the present invention provide improved tools for schema matching. An embodiment of the present invention applies the concept of so called matching processes. These processes support the manual task of configuring a sequence of match algorithms and mapping operators. In an embodiment, the matching processes are executable, reusable and can easily be adjusted to new mapping use cases. The processes consist of a simple data model and a set of operators. An embodiment implements a tool for simple visual configuration of the process in a model based fashion. That tool offers support for matching process debugging and incremental execution which helps to improve the result quality of a matching process.

Instead of offering a huge set of parameters, an embodiment allows the user to configure a matching service by the aforementioned matching processes. This extends to other use cases where the matching library is not used remotely but is integrated into the respective product. According to an embodiment, adjusting the auto matching to the specific use case implies modeling a matching process. Therefore changing the configuration after a product was shipped is easy, and can be done by exchanging the respective matching process configuration.

An embodiment of the present invention allows for a graphical flexible combination and configuration of matchers. The matching process approach unifies composite and hybrid matcher approaches and combines the advantages of both. The matching processes provide both the flexibility for adding and configuring matchers as well as the performance improvements that can be achieved by hybrid matchers.

An embodiment of the present invention provides improved automation and reusability. This is useful for separating matching functionality from configuration. This separation is useful when an auto-matching system is offered as a remote service.

In one embodiment the present invention includes computer-implemented method of performing schema matching. The method includes storing, by a computer system, a schema mapping that includes nodes. The schema mapping indicates a relationship between a first schema and a second schema. The method includes displaying, at a first node of the plurality of nodes, a graphical indication of the schema mapping at the first node. The method includes receiving, by the computer system, an evaluation of the schema mapping at the first node according to a user evaluating the graphical indication. The method includes adjusting the schema mapping as a result of the user evaluating the graphical indication. The method includes stepping, by the computer system, to a second node of the plurality of nodes. The method includes further displaying, receiving and adjusting the schema mapping as related to the second node.

According to an embodiment, a computer program implements the schema matching method described above.

According to an embodiment, a computer system implements the schema matching method described above. The computer system may be controlled by a computer program.

The following detailed description and accompanying drawings provide a better understanding of the nature and advantages of the present invention.

### BRIEF DESCRIPTION OF THE DRAWINGS

FIG. 1 shows a visual notation for matching processes according to an embodiment of the present invention.

FIG. 2 is a block diagram of an overall system architecture 200 according to an embodiment.

FIG. 3 is a diagram 300 showing two schemas 302 and 304 and a ground truth mapping 306 that is exemplary for a domain of mapping problems.

FIG. 4 is a process graph 400 showing an example of parallel composition.

FIG. 5 is a process graph 500 showing a more complex matching strategy.

FIG. 6 shows an example of a visualization of a matching process (graph) 600 for the example diagram 300 (see FIG. 3), according to an embodiment of the present invention.

FIG. 7 shows the visualization example of FIG. 6 once the start button 618 has been pressed, according to an embodiment of the present invention.

FIGS. 8A-8B show examples of the visualizations of intermediate results, according to an embodiment of the present invention.

FIG. 9 shows a modified matching process 900 that corresponds to the matching process 600 (see FIG. 6) with the addition of a filter 902, according to an embodiment of the present invention.

FIGS. 10A-10B show examples of the visualizations of intermediate results, according to an embodiment of the present invention.

### DETAILED DESCRIPTION

Described herein are techniques for schema matching. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

The following description presents a matching process that is based on a graph model. The matching process includes data types and a standard set of operations. The matching process also includes details on how it visually supports a user in creating matching processes. The matching process includes a design tool that implements process debugging and incremental execution. The matching process may be implemented by a machine architecture that includes a remote matching service that is configurable by pre-modeled matching processes.

Matching Graph and Matching Process

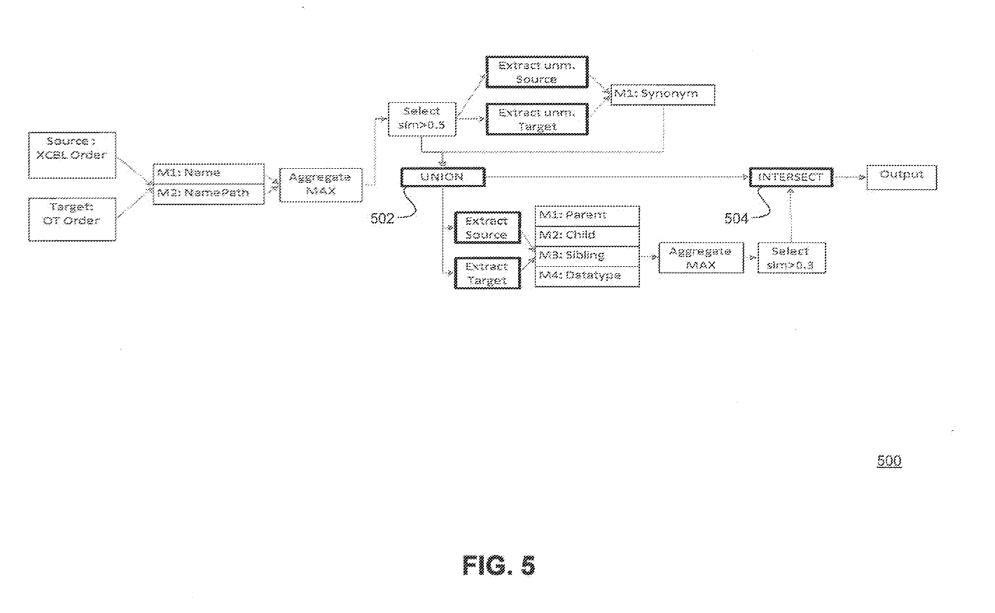

According to an embodiment, a matching process is described by an acyclic directed graph. FIGS. 4-7 and 9 (discussed in more detail below) show examples of these graphs. Edges within the graph (note, for example, in FIG. 4 the Schema 1 and Schema 2 are input edges, and the Mapping is an output edge) represent the data flow of two types of data structures: Schema and Mapping. The graph vertices (note, for example, the other boxes in FIG. 4) represent matching operations that subsume match algorithms as well as high-level operations. These operations operate on the data of the input edges and produce data on the output edges. Each edge and vertex can be annotated with a set of properties represented as key value pairs. A matching process contains all steps necessary to come from two input schemata to a final mapping. The input of the matching process is not restricted to source and target schemata (note Source: XCBL Order and Target: OT Order in FIG. 5); multiple schemata or mappings are also allowed as input of the matching process. Similarly, the output of the matching process is usually a mapping but can also be arbitrary. The operations are typed. This implies that the sequence of operations within the process is arbitrary and is only restricted by the input and output data of the individual operations, e.g., some operations in the graph need mappings as input whereas others process schemas. To support the reuse of existing matching processes, the matching process allows to encapsulate a subgraph in a process graph. This may be hidden behind a subgraph operation that can be used like any other operation in the graph. The intention is that subgraphs can be provided by matching experts and can be stored in a repository of processes. These mapping processes can then be used by a process designer to quickly define new matching processes.

Graph Data Types

According to an embodiment, two data types are used: mappings and schemas. This means that all operations' inputs and outputs are either mappings, schemas or both. A single type of schema may be used that does not differentiate between schema fragments and whole schemas. The schema type is generic and refers to any structure that can be matched such as trees, ontologies, models, as well as database schemas. A schema (edge) S consists of a list of schema elements s. Each schema element s has a name n, a data type t, one or no parent schema element p, and a set of children schema elements C. An intermediate partial schema contains the reference to the original source schema Sorig.

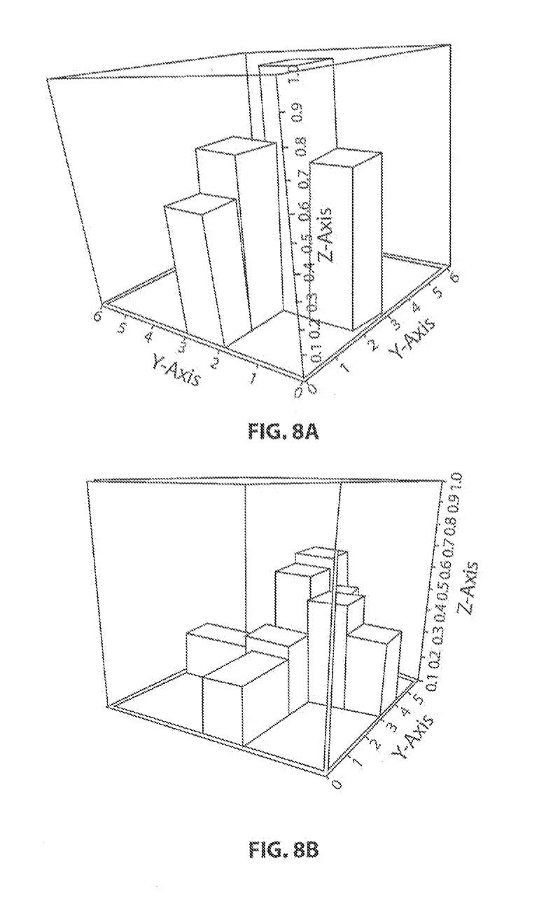

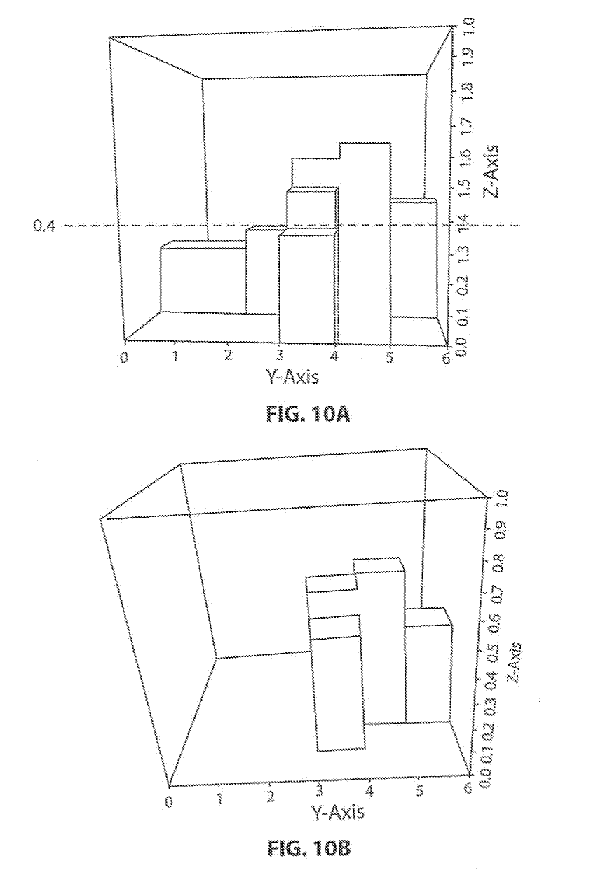

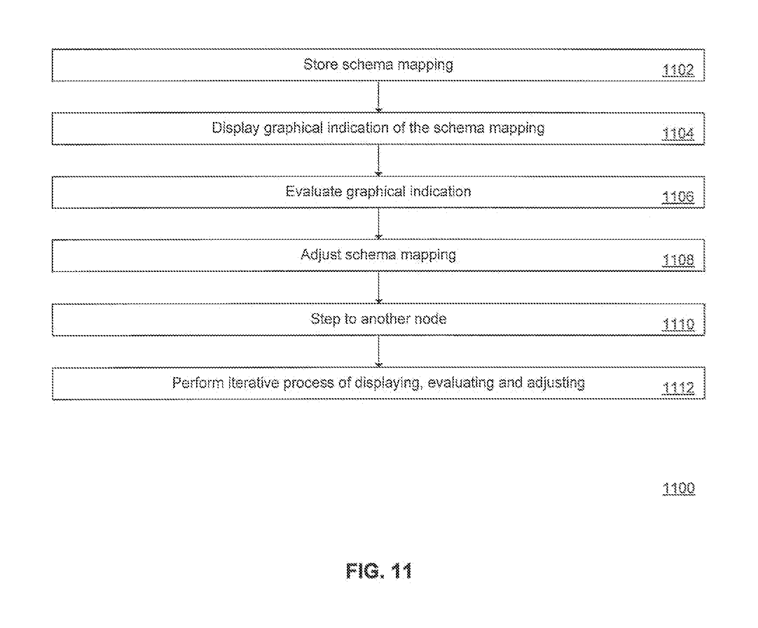

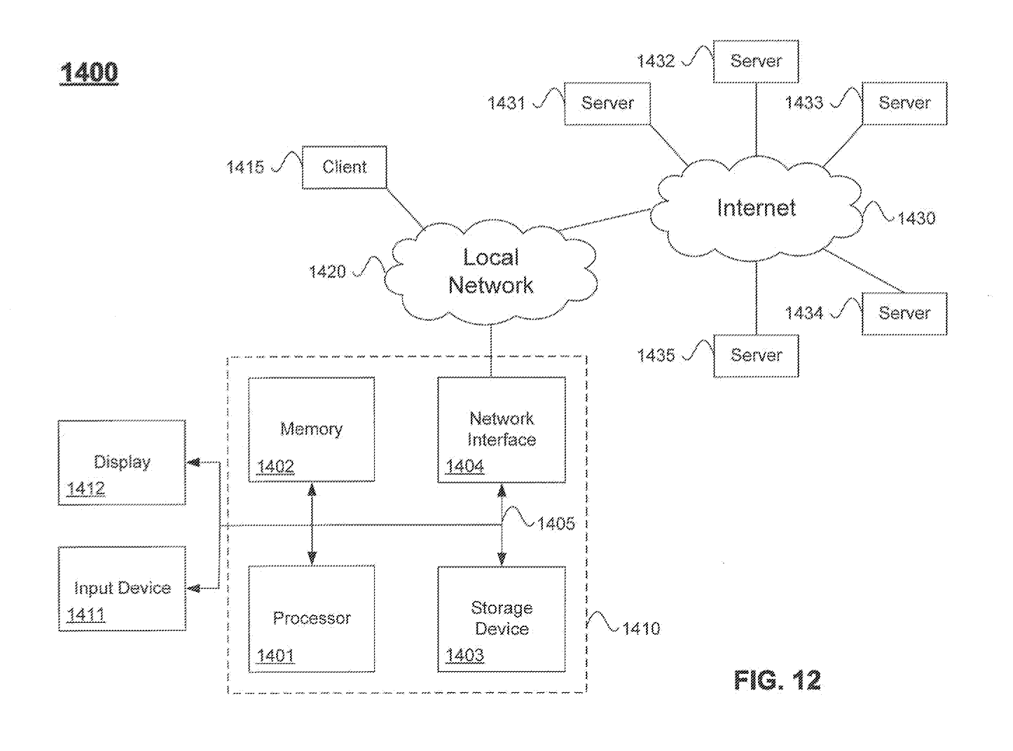

A mapping (edge) M between a source schema S and target schema T is a matrix A=(aij) with Sj*Tj cells. Sj (Tj) is the number of schema elements of the source (target) schema. The matrix has s rows and t columns. Each cell aij contains a value between 0 and 1 representing the similarity between the ith element of the source schema and the jth element of the target schema. The value 0 is the maximal possible dissimilarity while the value 1 is the maximal possible similarity. A mapping has an associated list with the names (or indices) of the schema elements of each schema: ls and lt. It contains furthermore references on the schemas S and T that are referred to as Refs and Reft. As an example, the graphical indications of FIGS. 8A-8B and 10A-10B show mappings.

Process Operations

TABLE 1

| Operation | | | |
|---|---|---|---|
| node type | Incoming edges | Outgoing edges | Operations |
| Match | Two Schemas | Mapping | Match |
| Mapping | Mapping | Mapping | Select, Filter |
| transformations | | | |
| Mapping | Multiple | Mapping | AggregateUnion, |
| operations | Mappings | | AggregateIntersect, |
| | | | AggregateDifference |
| Schema | Schema | Schema | SchemaSelection, |
| transformations | | | SchemaTransform |
| Schema | Mapping | Schema | ExtractMapped- |
| reconstruction | | | Source/Target, |
| | | | ExtractUnmapped- |
| | | | Source/Target |

TABLE 1 shows a set of operation types according to an embodiment. Some of the given operations are similar to operations defined in other work. See, e.g., H.-H. Do, Schema Matching and Mapping Based Data Integration, PhD thesis (University of Leipzig, 2005); A. Thor and E. Rahm, MOMA—a mapping-based object matching system (CIDR, 2007); and P. A. Bernstein, S. Melnik, M. Petropoulos, and C. Quix, Industrial-strength schema matching, in SIGMOD Record, 33 (2004). The operation nodes can be classified into five types according to the incoming and outgoing edges. Each group of operations is described in more detail below.

One noteworthy operation is the Match operation o. It takes a source schema S and a target schema T and returns a mapping A: A=o(S;T). The configuration comprises the specification of an algorithm and the provision of additional data the algorithm needs such as a dictionary, instance data, etc. As an example, FIG. 5 shows numerous Match operations (note the boxes with M1, M2, etc.).

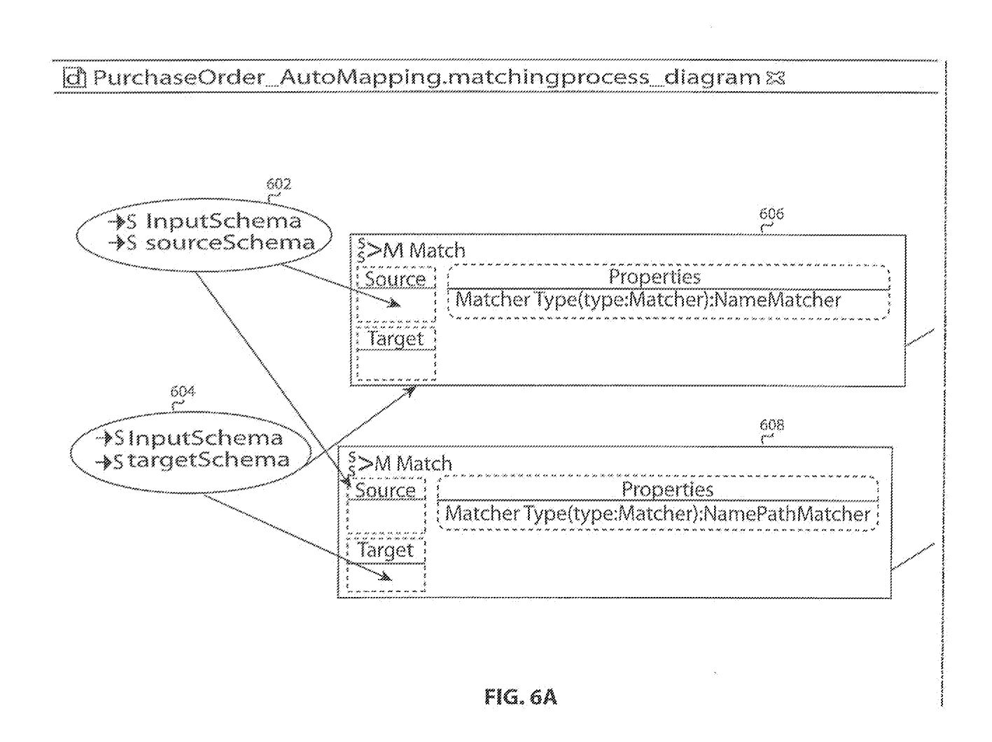

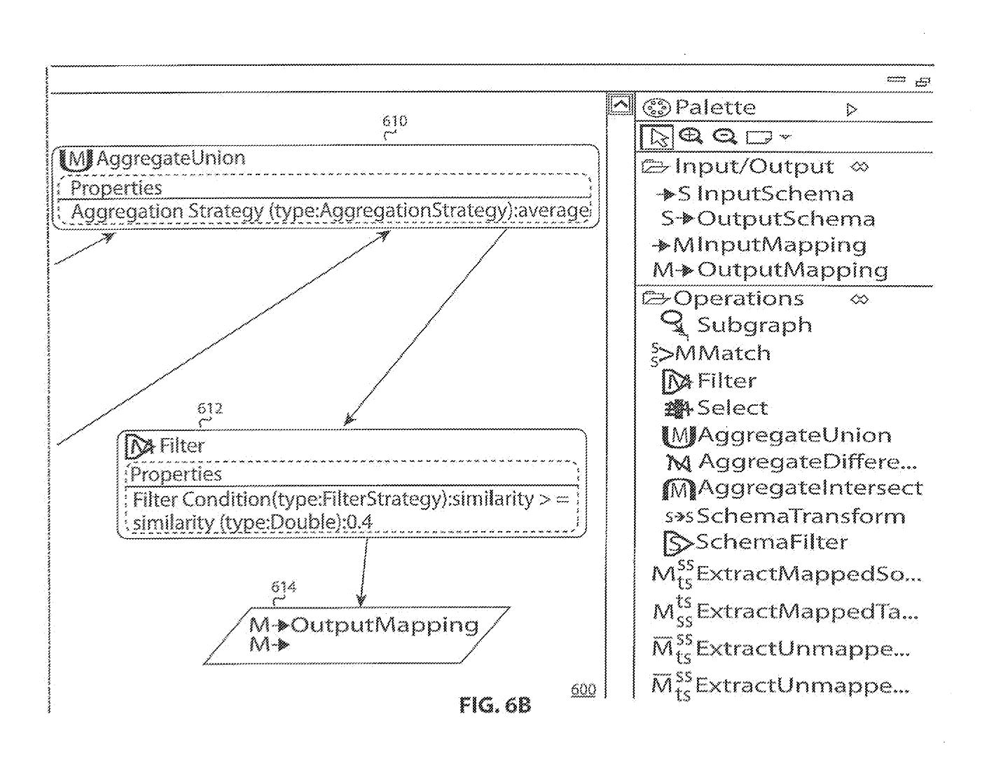

According to an embodiment, two operations manipulate mappings: Select and Filter. The Select operation takes a mapping A and produces a mapping B. It applies a condition c on each cell. The condition c is formulated about the cell, its row (representing the source schema) and its column (representing the target schema). If the condition evaluates to true, the cell is part of mapping B. If the condition evaluates to false, the value of the cell is set to 0. An example of the Select operation can be seen in FIG. 5. The Filter operation applies the filter condition c to the entries of mapping A and thus produces mapping B. The output mapping is then reduced (see the Select operation). An example of the Filter operation can be seen in FIG. 6 (note the filter node 612).

According to an embodiment, three operations aggregate mappings: AggregateUnion, AggregateIntersect, and AggregateDifference. The AggregateUnion operation takes n mappings A1 . . . . An that refer to the same source and target schemas and aggregates them to a single mapping B using the aggregation function f. The entries of B are computed by bij=f(a1ij . . . anij). The input mappings may have different sizes and they may overlap. All non-existing entries in an input mapping (compared to the original schemas) are assumed to have the value 0. The output mapping is then reduced (see the Select operation). An example of the AggregateUnion operation can be seen in FIG. 6 (note the node 610).

The AggregateIntersect operation takes n mappings A1 . . . An that refer to the same source and target schemas and produces a mapping B. An entry in B contains a value greater than 0 only for those cells that have a value greater than 0 in all input mappings. The value is calculated applying aggregation function f: bij=f(a1ij . . . akij) iff for all k: akij>0 otherwise bij=0. The input mappings may have different sizes and they may overlap. All non-existing entries in an input mapping (compared to the original schemas) are assumed to have the value 0. The output mapping is then reduced (see the Select operation).

The AggregateDifference operation take as input two or more mappings A1 . . . An that refer to the same source and target schemas and produce a new mapping B containing those correspondences (cells with value>0) that are in the first mapping but not in the other one. The input schemas may have different sizes and they may overlap. All non-existing entries in an input mapping (compared to the original schemas) are assumed to have the value 0. The output mapping is then reduced (see the Select operation).

According to an embodiment, the schema manipulation operations are SchemaSelection and SchemaTransform. The SchemaSelection operation selects a schema T from the input schema S according to a condition c. A condition c is formulated about the properties of a schema element which are name, data type, parent-, and children-relationships.

The SchemaTransform operation transforms Schema S to Schema T according to operation o: T=o(S). The operation could for example add structure to the schema. The number of schema elements and their order are immutable. SchemaTransform could be used to change the datatype of an element to better prepare it for matching.

According to an embodiment, to perform several matching operations in a sequence, there are four operations that reconstruct schemas from mappings: ExtractMappedSource, ExtractMappedTarget, ExtractUnmappedSource, and ExtractUnmappedTarget. The ExtractMappedSource (ExtractMappedTarget) operation extracts the part of the source (target) schema S (T) from a mapping M that has been mapped successfully, i.e., the source (target) schema Smapped (Tmapped) contains only the elements whose indices are contained in ls (lt). We introduce a function construct(x,l) that is able to construct a schema from the schema reference x and a list of element indices l. Given that function, the ExtractMappedSource operation is defined as: Smapped=construct(Refs; l). Note that ls contains a subset of element indices in S due to applied reductions throughout the mapping process.

The ExtractUnmappedSource (ExtractUnmappedTarget) operation extracts the part of the source (target) schema S (T) from a mapping M that has not been mapped successfully, i.e., the source (target) schema Sunmapped (Tunmapped) contains only the elements whose indices are not contained in ls (lt) Sunmapped=construct(Refs; (l(S)nls)). Note that l(S) refers to a function that returns all element indices in the source schema S. Examples of the ExtractUnmappedSource and ExtractUmnappedTarget operations can be seen in FIG. 5 (note Extract unm. Source and Extract unm. Target).

Visual Editing of the Graph

Apart from the formal definition of the graph and a set of operators, an embodiment implements the application of the matching processes in an industrial mapping tool. Features include that it is simple for a mapping expert to create, reuse and maintain mapping processes.

An embodiment includes a data model, a set of operators, and visual support. The matching process is visualized as a graph. This graph visualization makes relationships between operations and data explicit. Operations can be added to the graph by using drag and drop from the set of operators and matchers. One feature of the matching processes is the ability to contain another matching process as a subgraph. Subgraphs need not be visualized directly but may be represented by a subgraph operation in order to hide their complexity. Since subgraphs can have different input and output, the “interface” to the subgraph is visualized. Additionally the tool allows the user to easily drill down the hierarchy of subgraphs.

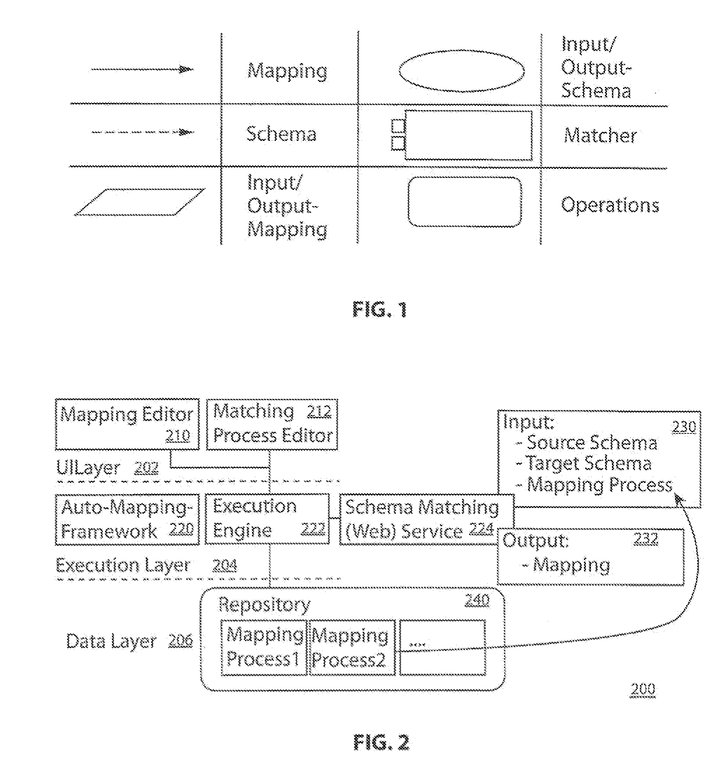

FIG. 1 shows a visual notation for matching processes according to an embodiment of the present invention. Solid and dashed arrows are used for mapping and schema data flow. Mappings are represented by parallelograms, schemas are represented by ovals, and matchers are represented by rectangles, and operations are represented by rounded rectangles. These structures may be referred to as nodes. Operation nodes may have different shapes and colors to distinguish them. Some operations have additional parameters like instance data or synonym dictionaries. This information may be provided in special property views. Some of the provided parameters are used to annotate the mapping process graph such as matcher names or aggregation strategies.

Support of Different User Groups

One problem with traditional matching systems is that only highly skilled experts are able to exploit the auto matching potential. And even for experts, the process requires a high manual effort. In contrast, an embodiment of the present invention supports two separate user groups for auto matching: the matching process user and the matching process designer. A matching process user is able to choose the best matching process out of a documented set of processes for his use case. The system controls the interaction and requests necessary input data like instances or synonyms from the user if needed.

The second group of users are matching process designers that model and tune matching processes to specific application areas. On request they are able to define new processes for given problem areas and store them in a central repository of best practices matching processes. The graphical support implemented according to an embodiment is useful for matching process designers.

Process Debugging and Incremental Execution

An embodiment of the present invention implements debugging of matcher processes. This allows a graph designer to incrementally step through a matching process. On each step the input and output of an operation as well as its parameters are visualized and can be changed using a graphical mapping view. Immediate feedback about the impact of parameter changes is given which helps to optimize individual parts of the process. The designer does not need to inspect concrete similarity values or matrices. Instead, the mapping visualization hides most of the complexity. Also the user is able to step back in a mapping process, change parameters and operators, and step forward with the applied changes. This backward/forward stepping is helpful in programming environments and helps to significantly improve the quality of a matching process. A user is able to exchange the order of operations, which could improve runtime performance. Matching process debugging is primarily intended for matching process designers. But a so-called incremental execution for matching process users is also implemented. This helps to address a common critique of the “one-shot” approach of many other existing matching systems. A matcher process is annotated with specific user interaction points where a user is asked to manually change the intermediate mapping result or relevant parameters. For instance a user could provide reference mappings early in execution of a process. These mappings are later used by other matchers to disambiguate mappings. This could improve the overall execution performance and quality since the reference mappings can be used as a hint for matchers within the process. Additionally dynamic parameterization of individual operators in a process depending on given mappings is provided.

Further details regarding incremental execution, and the resulting visualizations, are provided in subsequent sections.

Architecture and Process Editor

FIG. 2 is a block diagram of an overall system architecture 200 according to an embodiment. The overall system architecture 200 may be implemented by a one or more computer systems (see FIG. 12).

The overall system architecture 200 includes three layers: a user interface (UI) Layer 202, an Execution Layer 204 and a Data Layer 206. These three layers may be implemented, for example, by a three tier architecture that includes a presentation tier (implementing the UI Layer 202), an applications tier (implementing the Execution Layer 204), and a database tier (implementing the Data Layer 206). The UI Layer 202 implements a visual Mapping Editor 210 and a Matching Process Editor 212. The Mapping Editor 210 may be used to generate and manipulate mappings (see, e.g., FIG. 6). The Matching Process Editor 212 may be used to step through a matching process and to display visualizations of generated intermediate mappings (as described in more detail below).

The Execution Layer 204 provides an auto mapping framework 220 and a matching process execution engine 222 that executes modeled processes. Also this layer offers a Schema Matching Service 224 that is able to be called remotely via the network. Given a schema matching process and two schemas (input 230), the Schema Matching Service 224 calls the execution engine 222 and returns a final mapping 232 that best fits to the caller's requirements. The auto mapping framework 220 contains the actual matchers as well as data structures representing schemata and mappings.

The Data (persistence) Layer 206 implements a repository 240 that is used to persist mapping, schemata and also best practices mapping processes for later reuse.

Details for Matching Process Debugging by Backward Forward-Stepping

An embodiment of the present invention allows a user to manually fine-tune individual parts of the overall semi-automatic matching process of matchers and operators. This fine tuning is done directly on the visual graph level, and even allows changing parameters directly in the graph. This fine-tuning is performed by stepping back and forth in the graph. In addition to the final results being visualized, also intermediate results are shown. The intermediate results are often more helpful than the final result in tuning the whole process.

In an embodiment of the present invention, for visualization of intermediate results, surface plots are applied that show a similarity matrix in a 3-d cube. The X and Y axes represent the source and target elements and the Z axis represents the sim-value. These plots help in defining selection threshold and analyzing the effect of a selection threshold without the requirements of executing and analyzing the final transformation. The 3-d visualizations serve as a short cut in differentiating true match results from noise.

In an embodiment of the present invention, an aspect is reuse. Each process can be reused as a subprocess within other processes. This makes it easy to construct and combine a number of domain-specific processes to a new composite. In combination with this, an embodiment supports zooming into a subprocess and zooming out.

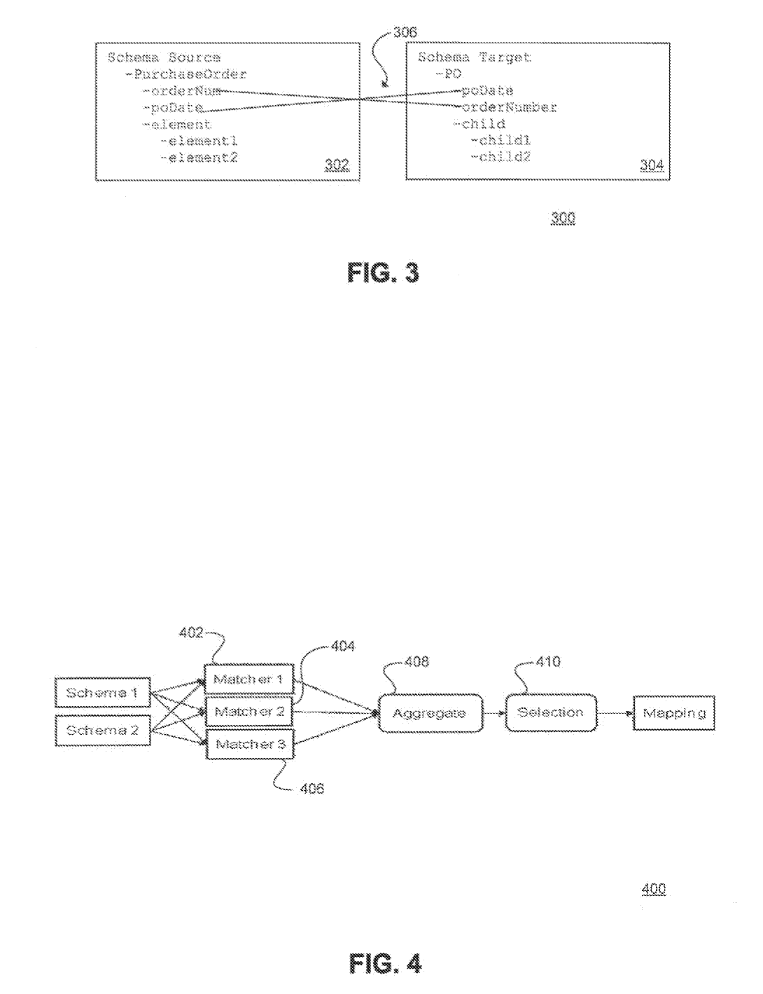

FIG. 3 is a diagram 300 showing two schemas 302 and 304 and a ground truth mapping 306 that is exemplary for a domain of mapping problems. The information in the diagram 300 will be used as an example in the following description.

FIG. 4 is a process graph 400 showing an example of parallel composition. The process graph 400 implements a matching strategy that was developed for other problem domains. A complex task in automatic schema mapping is to find a good configuration for mapping problems. A common matching strategy is to use combined strategies, e.g., to execute a number of matchers in parallel (note the matchers 402, 404 and 406) and aggregate their individual similarity matrices (note the aggregator 408) to a single matrix. After that the selection 410 prunes mappings of pair that are lower than a given threshold.

As an example, consider that the process graph 400 is being used to generate a mapping for the schemas 302 and 304 (see FIG. 3). The ideal result is that the resulting mapping will correspond to the ground truth mapping 306.

FIG. 5 is a process graph 500 showing a more complex matching strategy. Recent schema matching contests in the ontology domain show that solutions with more sophisticated processes with stages and filters often provide better results. All these systems (for example, RiMOM [Risk Minimization based Ontology Mapping] schema matching, COMA++[COmbining MAtch] schema matching, and FalconAO [Falcon Aligning Ontologies] schema matching) have fixed order of matchers and operators and need to find the respective parameterization of individual operators on the code level. More importantly operators for UNION 502 and INTERSECT 504 are often applied manually.

The flow of the process graph 500 may be described as follows. In the given Example the XCBL Order schema and the OpenTrans (OT) Order schema are matched. In a first stage two matchers are executed in parallel composition and generate a mapping. Their result mappings are aggregated to a single mapping using the MAX-Aggregation that only keeps the best match-result-similarities for two element pairs. The Select-operation prunes mappings with similarity smaller than 0.5. From the output of the selection that prunes mappings with similarity smaller than 0.5, only the non-mapping source and target schemata parts are extracted using the Extract-operations. These extracted source and target schema elements are put into a second matching stage where they are matched using a synonym-matcher to identify additional mappings. The result of the first and second stage are put together using a UNION-Operation.

A third stage extracts the source and target schema of the UNION-result and executes a number of structural matchers and a datatype-matcher in parallel composition. Again the result of these matchers is aggregated to a single mapping, similarities are pruned if they are below 0.3 and the result mapping is intersected with the result from the first two stages.

An embodiment of the present invention models processes graphically and includes features that allow stepping through a complex process and visualizing the intermediate result of an operator. Parameters can be changed on the fly and immediately the effect can be investigated.

FIG. 6 shows an example of a visualization of a matching process (graph) 600 for the example diagram 300 (see FIG. 3), according to an embodiment of the present invention. In this process two input schemas 602 and 604 (corresponding to the schemas 302 and 304 of FIG. 3) are used as input for two matchers 606 and 608. The matcher 606 is a name matcher and the matcher 608 is a namepath matcher. Afterwards the result is aggregated (note the AggregateUnion node 610) and filtered (note the Filter node 612).

Ideally, the output mapping 614 corresponds to the ground truth mapping 306 (see FIG. 3). Unfortunately, the matching process 600 generates an incorrect mapping from PurchaseOrder to orderNumber (note the labels in the schemas 302 and 304 in FIG. 3) which should not be generated. The problem for a matching expert is now, to find out why this strategy does generate a wrong match. He could jump into the code and debug, or he could change parameters and see how the result changes. Both are complex and require a lot of expertise and experience.

Alternatively, the matching expert can use an embodiment of the present invention to debug the graph and analyze the result. A user interface component of an embodiment implements a control bar with the control buttons start, stop, forward, and reverse. The user can start the debugging by pressing the start button.

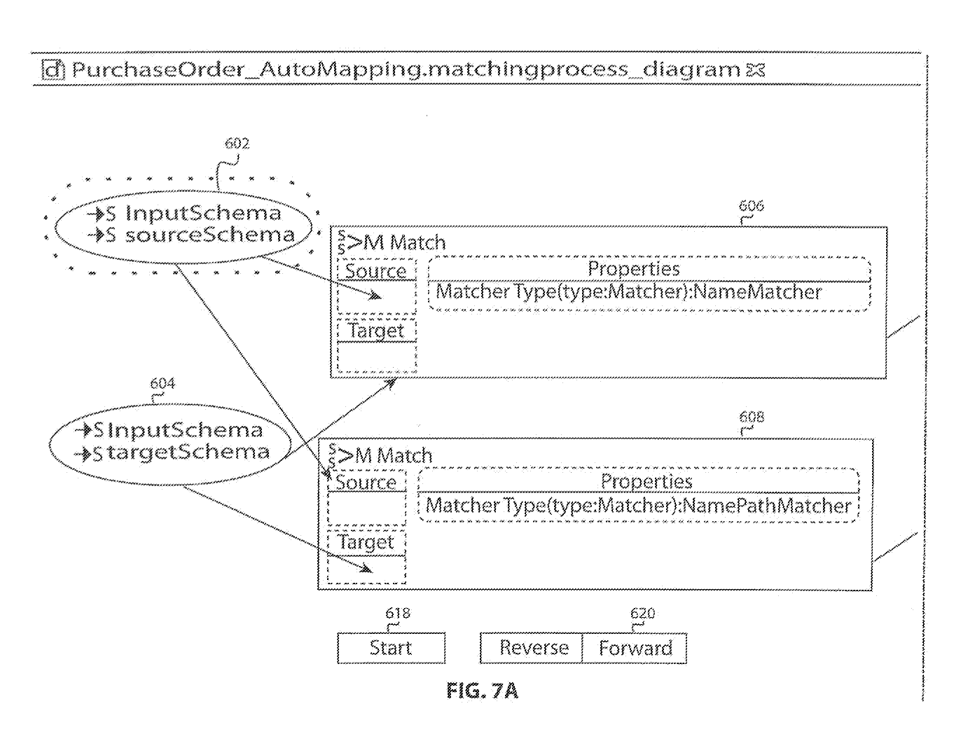

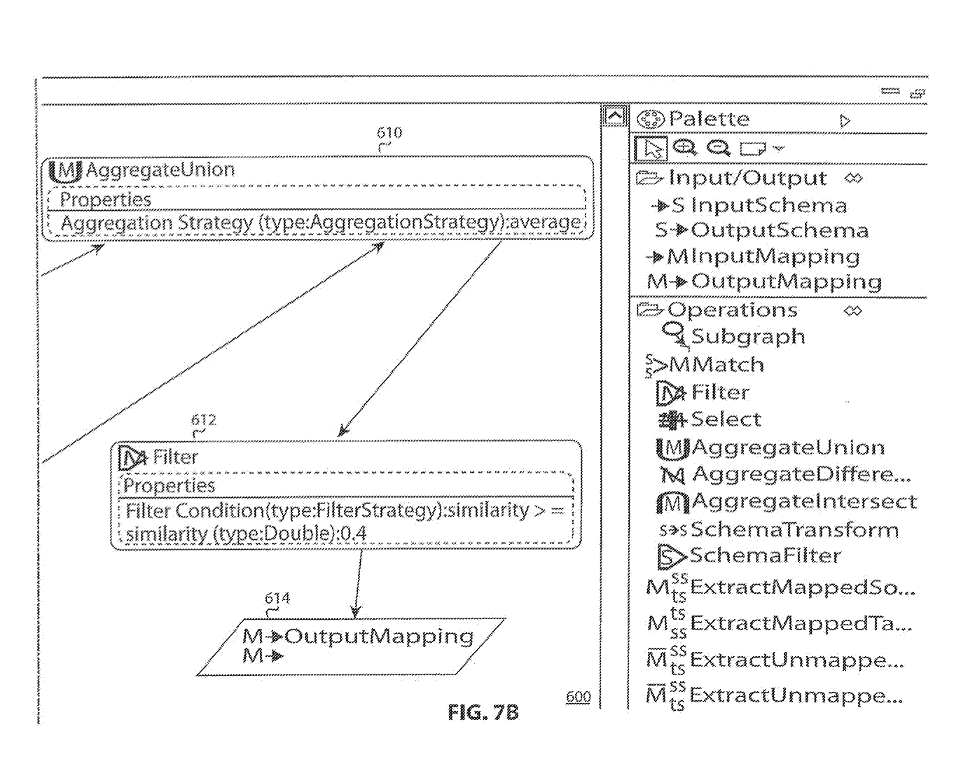

FIG. 7 shows the visualization example of FIG. 6 once the start button 618 has been pressed, according to an embodiment of the present invention. The current step of execution, the input node 602 (the source schema), becomes highlighted. For stepping back and forth in the graph 600, the forward and reverse buttons 620 may be used. For example, stepping forward from the input node 602 steps to the matcher node 606, which then becomes highlighted (not shown).

FIGS. 8A-8B show examples of the visualizations of intermediate results, according to an embodiment of the present invention. When a step is reached where intermediate results are generated (e.g., the matcher node 606), the results are visualized using a mapping surface plot. The X and Y axes are the schema elements and the Z-Axis represents similarity values. FIG. 8A shows the results at node 606. When the execution steps to the NamePathMatcher node 608, the intermediate results of FIG. 8B are shown. Each box in the plot represents a single computed similarity-value. If the box is high, the similarity is high, and vice versa. Often similarities are clustered. Noise could be seen as very small boxes at the bottom of the plot.

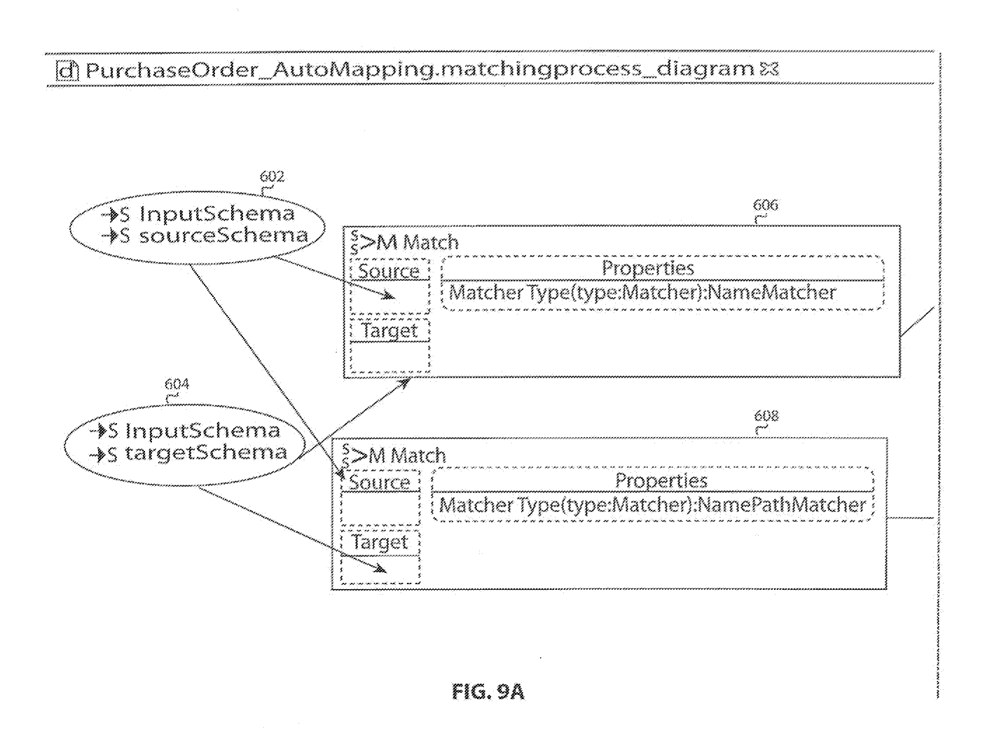

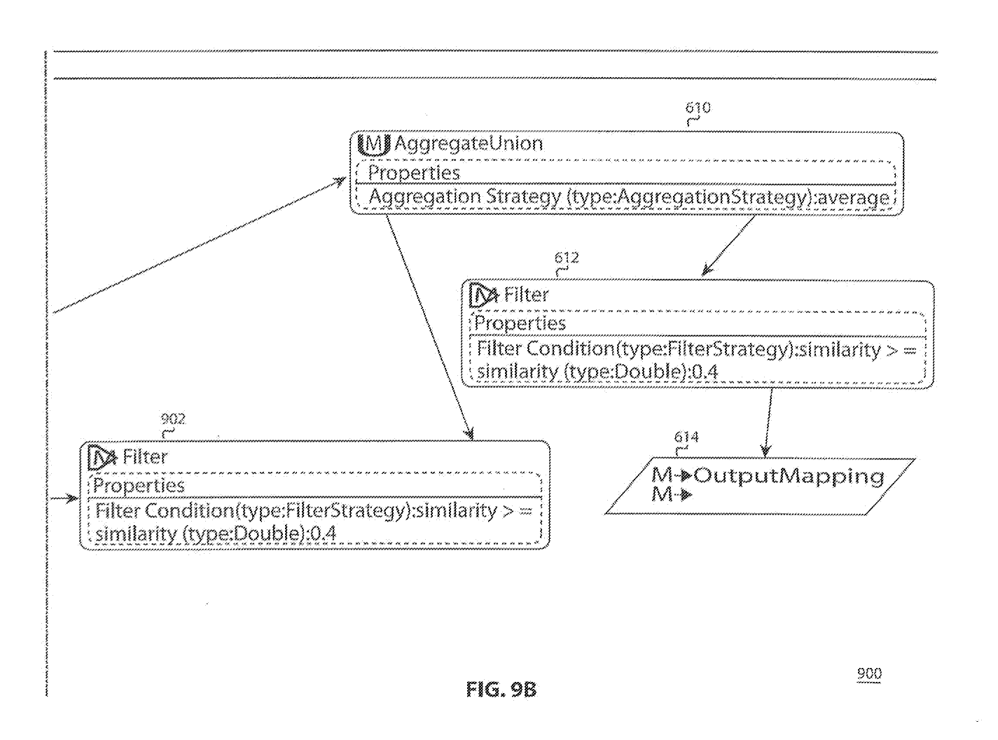

What can be seen from the surface plot of FIG. 8B is that there is quite some noise at the bottom where similarity values are created that will never produce good results. For that reason a filter may be put after the namePathMatcher node 608 that filters out possible noise, as shown in FIG. 9.

FIG. 9 shows a modified matching process 900 that corresponds to the matching process 600 (see FIG. 6) with the addition of a filter 902, according to an embodiment of the present invention. The filter 902 filters the output of the matcher node 608 prior to its input to the aggregation node 610. The filter function is a generic function that is implemented with specific parameters at a node, as indicated by the filter 902. A filter node generally refers to a node that implements the filter function. A filter value is the threshold value to which the filter operates; for example 0.4 in the case of the filter 902. The filter function, when implemented in a node, may be referred to as a filter operator.

FIGS. 10A-10B show examples of the visualizations of intermediate results, according to an embodiment of the present invention. FIG. 10A shows the intermediate results resulting from the output of the node 608, and FIG. 10B shows the intermediate results resulting from the output of the filter node 902. (The filter node prunes result-mappings that are below a given threshold; the threshold is the filtervalue.) When investigating the surface plot of FIG. 10A, the user can see that it is reasonable to set the filter at 0.4 (note the Z-Axis in FIG. 10A). When stepping to the new Filter-Operator (node 902), the noise is pruned out as visualized in FIG. 10B. As a result of adding the filter node 902, when executing the whole changed process, the result corresponds to the ground truth (see FIG. 3).

Certainly identifying the noise in that example is not as easy as described, but with bigger examples it is simple to set the right parameters after watching the surface plot.

FIG. 11 is a flowchart of a method 1100 of performing schema matching according to an embodiment of the present invention.

At 1102, a schema mapping is stored by the computer system. The schema mapping includes a number of nodes and indicates a relationship between a first schema and a second schema. For example, consider the structures illustrated in FIGS. 4-6 to be examples of schema mappings.

At 1104, a graphical indication of the schema mapping at one of the nodes is displayed. In general, “graphical indication” refers to a visual representation of a similarity matrix. For example, consider the graphical indication of FIG. 8B corresponding to the node 608 (see FIG. 6). The node may be the first node in the schema mapping, or may be another selected node. The type and appearance of graphical indication may vary depending upon the embodiment, upon user preferences, and other considerations. For example, 3-dimensional bar graphs as shown in FIG. 8A-8B shows the similarity matrix in a way that gives a compact idea of the similarity distributions of a mapping result. According to an embodiment, the thicknesses of lines between nodes of the schema mapping may be used to show the similarity distributions. According to an embodiment, the colors of lines between nodes of the schema mapping may be used to show the similarity distributions. According to an embodiment, source and target entries may be arranged in a table to show the similarity distributions. According to an embodiment, the resulting similarity matrix is displayed to shown the similarity distributions.

At 1106, a user evaluates the graphical indication as an evaluation of the schema mapping at that particular node. For example, consider that the user evaluates the graphical indication of FIG. 8B to determine that the schema mapping may benefit from adjustment. The computer system receives the evaluation.

At 1108, the user adjusts the schema mapping as a result of the user evaluating the graphical indication (see 1106). For example, consider that the user adds the filter node 902 to the schema mapping as shown in FIG. 9. As part of the adjustment, the user may add one or more nodes that perform one or more of the functions described above (e.g., union, intersection, aggregation, extraction, selection, etc.), or may adjust the parameters in a function (e.g., the threshold of a filter). The computer system receives the adjustment.

At 1110, the computer system steps to another node. This may be in response to the user interacting with the computer system with a user interface to the schema matching system such as forward and back buttons. The other node may be adjacent to the first node, for example, preceding or succeeding the first node.

At 1112, an iterative process of displaying (see 1104), evaluating (see 1106) and adjusting (see 1108) is performed for the other node. The iterative process may be further performed for still other nodes in the schema mapping. As a result, the schema mapping may be easily debugged in a more efficient manner than that of many existing systems. For example, consider schema mappings of FIG. 7 and FIG. 9. By iteratively stepping through the nodes of FIG. 7 according to the method 1100, the user evaluates the graphical indications at each node. As a result of the evaluations, the user adjusts the schema mapping to add the filter 902 (see FIG. 9). The user may then iteratively step through the nodes of FIG. 9 to evaluate the accuracy of the schema mapping.

The method 1100 may be implemented by a computer system (see, e.g., FIG. 12) that executes one or more computer programs. The computer programs may have an architecture similar to that shown in FIG. 2. For example, the repository 240 may store the schema mapping (see 1102). The Matching Process Editor 212 may display the graphical indication of the schema mapping (see 1104). The Mapping Editor 210 may be used to adjust the schema mapping (see 1108). The execution engine 222 implements the iterative stepping between nodes (see 1110 and 1112).

FIG. 12 is a block diagram of an example computer system and network 1400 for implementing embodiments of the present invention. Computer system 1410 includes a bus 1405 or other communication mechanism for communicating information, and a processor 1401 coupled with bus 1405 for processing information. Computer system 1410 also includes a memory 1402 coupled to bus 1405 for storing information and instructions to be executed by processor 1401, including information and instructions for performing the techniques described above. This memory may also be used for storing temporary variables or other intermediate information during execution of instructions to be executed by processor 1401. Possible implementations of this memory may be, but are not limited to, random access memory (RAM), read only memory (ROM), or both. A storage device 1403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1403 may include source code, binary code, or software files for performing the techniques or embodying the constructs above, for example.

Computer system 1410 may be coupled via bus 1405 to a display 1412, such as a cathode ray tube (CRT) or liquid crystal display (LCD), for displaying information to a computer user. An input device 1411 such as a keyboard and/or mouse is coupled to bus 1405 for communicating information and command selections from the user to processor 1401. The combination of these components allows the user to communicate with the system. In some systems, bus 1405 may be divided into multiple specialized buses.

Computer system 1410 also includes a network interface 1404 coupled with bus 1405. Network interface 1404 may provide two-way data communication between computer system 1410 and the local network 1420. The network interface 1404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 1404 sends and receives electrical, electromagnetic, or optical signals that carry digital data streams representing various types of information.

Computer system 1410 can send and receive information, including messages or other interface actions, through the network interface 1404 to an Intranet or the Internet 1430. In the Internet example, software components or services may reside on multiple different computer systems 1410 or servers 1431, 1432, 1433, 1434 and 1435 across the network. A server 1431 may transmit actions or messages from one component, through Internet 1430, local network 1420, and network interface 1404 to a component on computer system 1410.

The computer system and network 1400 may be configured in a client server manner. The client 1415 may include components similar to those of the computer system 1410.

More specifically, the client 1415 may implement the UI Layer 202 (see FIG. 2). The computer system 1410 may implement the Execution Layer 204 (see FIG. 2). The server 1431 may implement the Data Layer 206 (see FIG. 2).

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A computer-implemented method of performing schema matching, comprising:
storing, by a computer system, a schema mapping that includes a plurality of nodes, wherein the schema mapping indicates a relationship between a first schema and a second schema;
displaying, at a first node of the plurality of nodes, a graphical indication of the schema mapping at the first node;
receiving, by the computer system, an evaluation of the schema mapping at the first node according to a user evaluating the graphical indication;
adjusting the schema mapping as a result of the user evaluating the graphical indication;
stepping, by the computer system, to a second node of the plurality of nodes; and
further displaying, receiving and adjusting the schema mapping as related to the second node.

2. The computer-implemented method of claim 1, further comprising:
debugging the schema mapping by iteratively displaying, evaluating and adjusting the schema mapping.

3. The computer-implemented method of claim 1, wherein the graphical indication corresponds to a three-dimensional representation of a similarity matrix.

4. The computer-implemented method of claim 1, wherein the second node is adjacent to the first node.

5. The computer-implemented method of claim 1, wherein the plurality of nodes comprises a start node and an end node, wherein the first node is other than the start node, and wherein the second node is other than the end node.

6. The computer-implemented method of claim 1, wherein the computer system steps to the second node in a reverse direction.

7. The computer-implemented method of claim 1, further comprising:
iteratively displaying, receiving and adjusting the schema mapping at each node of the plurality of nodes.

8. The computer-implemented method of claim 1, wherein adjusting the schema mapping includes adding a filter node to the plurality of nodes.

9. The computer-implemented method of claim 1, wherein the plurality of nodes includes a match node that receives two schemas, that perfolins a match operation, and that outputs a mapping.

10. The computer-implemented method of claim 1, wherein the plurality of nodes includes a mapping transformation node that receives a first mapping, that performs at least one of a select operation and a filter operation, and that outputs a second mapping.

11. The computer-implemented method of claim 1, wherein the plurality of nodes includes a mapping operation node that receives a plurality of mappings, that performs at least one of a union operation, an intersection operation and a difference operation, and that outputs a single mapping.

12. The computer-implemented method of claim 1, wherein the plurality of nodes includes a schema transformation node that receives a first schema, that performs at least one of a schema selection operation and a schema transform operation, and that outputs a second schema.

13. The computer-implemented method of claim 1, wherein the plurality of nodes includes a schema reconstruction node that receives a mapping, that performs an extraction operation, and that outputs a schema.

14. A computer program, embodied on a tangible recording medium, for controlling a computer system to perform schema matching, the computer program comprising:
a repository program that is configured to control the computer system to store a schema mapping that includes a plurality of nodes, wherein the schema mapping indicates a relationship between a first schema and a second schema;
a matching process editor program that is configured to control the computer system to display, at a first node of the plurality of nodes, a graphical indication of the schema mapping at the first node;
a mapping editor program that is configured to control the computer system to receive, from the user, an adjustment to the schema mapping as a result of the user evaluating the graphical indication; and
an execution program that is configured to control the computer system to step to a second node of the plurality of nodes,
wherein the computer program is configured to control the computer system to further adjust the schema mapping according to further execution of the display program and the adjustment program, as related to the second node.

15. The computer program of claim 14, wherein the computer system manages debugging of the schema mapping by iteratively displaying and adjusting the schema mapping in accordance with the user evaluating the graphical indication.

16. The computer program of claim 14, wherein the graphical indication corresponds to a three-dimensional representation of a similarity matrix

17. The computer program of claim 14, wherein the plurality of nodes includes a filter node.

18. The computer program of claim 14, wherein the plurality of nodes includes a mapping transformation node.

19. The computer program of claim 14, wherein the plurality of nodes includes a mapping operation node.

20. A system for performing schema matching, comprising:
a client computer that is configured to implement a user interface layer;
an application server that is configured to implement an execution layer; and
a database server that is configured to implement a data layer,
wherein the database server is configured to store a schema mapping that includes a plurality of nodes, wherein the schema mapping indicates a relationship between a first schema and a second schema,
wherein the client computer is configured to display, at a first node of the plurality of nodes, a graphical indication of the schema mapping at the first node,
wherein the application server is configured to adjust the schema mapping as a result of the user evaluating the graphical indication,
wherein the application server is configured to step to a second node of the plurality of nodes, and
wherein the application server is configured to further adjust the schema mapping according to further display and adjustment, as related to the second node.
